(19) United States
(12) Patent Application Publication
(10) Pub. No.: US 2021/0325799 A1
(43) Pub. Date: Oct. 21, 2021

(54) IMAGING SYSTEM

(71) Applicant: HEWLETT-PACKARD DEVELOPMENT COMPANY, L.P., Spring, TX (US)

(72) Inventor: Hiroaki YOSHIDA, Yokohama (JP)

(73) Assignee: HEWLETT-PACKARD DEVELOPMENT COMPANY, L.P., Spring, TX (US)

(21) Appl. No.: 17/269,447

(22) PCT Filed: Aug. 26, 2019
(86) PCT No.: PCT/US2019/048088

§ 371 Date: Feb. 18, 2021

(30) Foreign Application Priority Data
Sep. 7, 2018 (JP) 2018-167922

(51) Int. Cl. G03G 15/08; G03G 9/10

(52) U.S. Cl. CPC G03G 15/0849; G03G 15/0812; G03G 9/10

(57) ABSTRACT

An imaging system includes a storage container, a separating device and a restoring device. The storage container stores a developer including carrier and toner having restoring properties. The separating device separates the developer in the storage container into the carrier and the toner. The restoring device restores properties of the carrier and the toner generated by the separating device.

### BACKGROUND

In some imaging systems, a developing technique called a two-component developing system may be used. In the two-component developing system, a developer is formed by carrier, toner, and external additive and the negatively charged toner is conveyed to a photosensitive member by the positively charged carrier. The external additive adheres to the surface of the toner, so that the fluidity, chargeability, and the like of the toner are improved.

### BRIEF DESCRIPTION OF DRAWINGS

FIG. 1 is a cross-sectional view illustrating a schematic configuration of an imaging apparatus as an example.

FIG. 2 is a vertical cross-sectional view of a developing device as an example.

FIG. 3 is a vertical cross-sectional view of a developing device as an example.

FIG. 4 is a vertical cross-sectional view of a developing device as an example.

### DETAILED DESCRIPTION

In the following description, with reference to the drawings, the same reference numbers are assigned to the same components or to similar components having the same function, and overlapping description is omitted. In some examples, an imaging system may be an imaging apparatus such as a printer. In some examples, an imaging system may include a developing device used in an imaging apparatus.

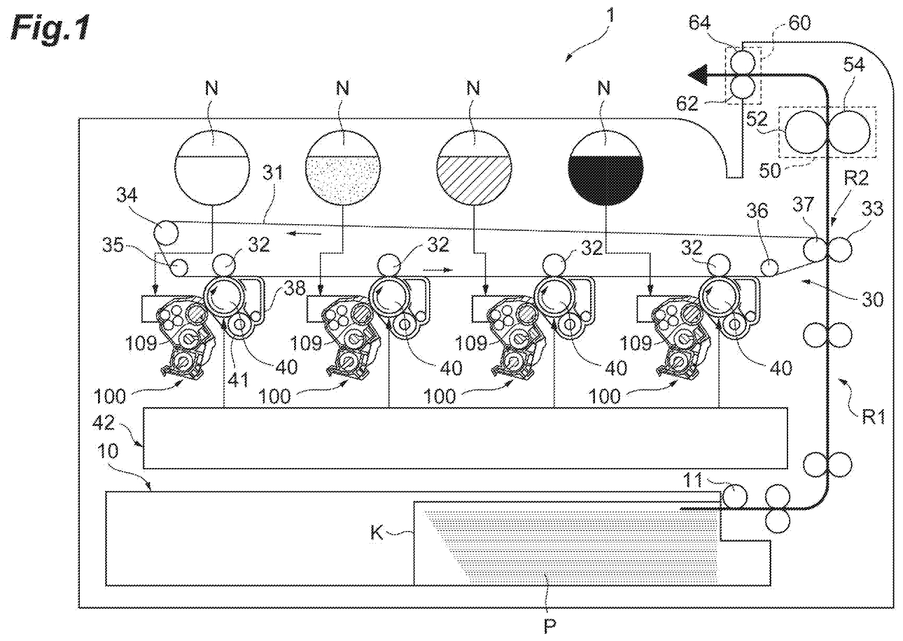

FIG. 1 schematically illustrates a configuration of an example imaging apparatus 1. The imaging apparatus (example imaging system) 1 illustrated in FIG. 1 may be an apparatus which forms a color image by using magenta, yellow, cyan, and black colors. The example imaging apparatus may include a conveying device 10 which conveys a sheet P corresponding to a recording medium, a developing device (imaging system) 100 which develops an electrostatic latent image, a transfer device 30 which secondarily transfers a toner image to the sheet P, an image carrier 40 in which an electrostatic latent image is formed on a surface (peripheral surface) thereof, a fixing device 50 which fixes a toner image to the sheet P, and a discharging device 60 which discharges the sheet P.

The conveying device 10 conveys the sheet P corresponding to a recording medium having an image formed thereon on a conveying route R1. The sheet P is stacked and accommodated on a cassette K and is picked up and conveyed by a feeding roller 11. The conveying device 10 allows the sheet P to reach a transfer nip portion R2 through the conveying route R1 at a timing in which the toner image transferred to the sheet P reaches the transfer nip portion R2.

The example imaging apparatus 1 may include four developing devices 100, one for each of the four colors (e.g. magenta, yellow, cyan, and black). Each developing device 100 may include a developer carrier 109 which carries toner on the image carrier 40. In the developing device 100, a two-component developer including carrier, toner, and external additive may be used as the developer. The carrier, the toner, and the external additive are mixed to adjust the developer. By this adjustment, the carrier is positively charged and the toner is negatively charged. The external additive is mainly adhered to the surface of the toner.

The developing device 100 transfers developer to the developer carrier 109. When the developer is carried by the developer carrier 109, to a region facing the image carrier 40, by the rotation of the developer carrier 109, the toner in the developer carried on the developer carrier 109 moves to the electrostatic latent image formed on the peripheral surface of the image carrier 40. By the movement of the toner, the electrostatic latent image is developed and the toner image is formed.

The transfer device 30 conveys the toner image formed by the developing device 100 to the transfer nip portion R2. The transfer device 30 may include a transfer belt 31 to which a toner image is primarily transferred from the image carrier 40, suspension rollers 34, 35, 36, and 37 on which the transfer belt 31 is suspended, a primary transfer roller 32 which sandwiches the transfer belt 31 along with the image carrier 40, and a secondary transfer roller 33 which sandwiches the transfer belt 31 along with the suspension roller 37.

The transfer belt 31 may be an endless belt which moves in a circulating manner by the suspension rollers 34, 35, 36, and 37. Each of the suspension rollers 34, 35, 36, and 37 has a rotation axis to rotate about the rotation axis. The suspension roller 37 is a driving roller which rotates about its rotation axis and the suspension rollers 34, 35, and 36 are driven rollers which are driven to rotate by the rotation of the suspension roller 37. The primary transfer roller 32 is provided to press the image carrier 40 from the inner peripheral side of the transfer belt 31. The secondary transfer roller 33 is disposed in parallel to the suspension roller 37 and the transfer belt 31 interposed between the secondary transfer roller 33 and the suspension roller 37. The secondary transfer roller 33 is provided to press against the suspension roller 37 from the outer peripheral side of the transfer belt 31. The transfer nip portion R2 is located between the transfer belt 31 and the secondary transfer roller 33.

The image carrier 40 may be an electrostatic latent image carrier in which an image is formed on a peripheral surface and is also referred to herein as a photosensitive drum. The image carrier 40 is formed by, for example, an organic photo conductor (OPC). The example imaging apparatus 1 is capable of forming a color image and includes four image carriers 40, one for each color. Each image carrier 40 is provided along the movement direction of the transfer belt 31. The image carrier 40 may have a columnar or cylindrical shape. The developing device 100, a charging roller 41, an exposure unit 42, and a cleaning unit 43 may be provided on the periphery of the image carrier 40.

The charging roller 41 may be a charging member that uniformly charges the surface of the image carrier 40 to a predetermined potential. The charging roller 41 moves to follow the rotation of the image carrier 40. The exposure unit 42 exposes the surface of the image carrier 40 charged by the charging roller 41 in response to an image formed on the sheet P. Accordingly, a potential of a portion exposed by the exposure unit 42 in the surface of the image carrier 40 changes so that an electrostatic latent image is formed. The four developing devices 100 generate a toner image by developing the electrostatic latent image formed on the image carrier 40 by the toner supplied from toner tanks N facing the respective developing devices 100. The toner tanks N are filled with magenta, yellow, cyan, and black toners, respectively. The cleaning unit 43 collects the toner remaining on the image carrier 40 after the toner image formed on the image carrier 40 is primarily transferred to the transfer belt 31.

The fixing device 50 may fix the toner image, secondarily transferred from the transfer belt 31 to the sheet P, to the sheet P as the sheet P is passed through the fixing nip portion for heating and pressing the sheet. The fixing device 50 may include a heating roller 52 which heats the sheet P and a pressing roller 54 which presses and rotates the heating roller 52. The heating roller 52 and the pressing roller 54 have a cylindrical shape. The heating roller 52 includes a heat source such as a halogen lamp provided therein. A fixing nip portion may be a contact region between the heating roller 52 and the pressing roller 54. The toner image is melted and fixed to the sheet P when the sheet P passes through the fixing nip portion.

The discharging device 60 may include discharging rollers 62 and 64 which discharge the sheet P having the toner image fixed thereto, to the outside of the apparatus.

An example printing process of the example imaging apparatus 1 will be described. When an image signal of a recording target image is input to the imaging apparatus 1, a control unit of the imaging apparatus 1 rotates the feeding roller 11 to pick up and convey the sheet P stacked on the cassette K. The control unit of the imaging apparatus 1 uniformly charges the surface of the image carrier 40 to a predetermined potential by the charging roller 41 (a charging operation). Subsequently, the control unit of the imaging apparatus 1 forms an electrostatic latent image by irradiating a laser beam to the surface of the image carrier 40 by the exposure unit 42 based on the received image signal (an exposing operation). As an example, the control unit may include an electronic control unit which includes a central processing unit (CPU), a read only memory (ROM), and a random access memory (RAM). In the control unit, various kinds of control are performed by executing a program using the CPU, the ROM, and the RAM.

The developing device 100 develops the electrostatic latent image of the image carrier 40 to form a toner image on the image carrier 40 (a developing operation). The toner image is primarily transferred from the image carrier 40 to the transfer belt 31 in a region in which the image carrier 40 and the transfer belt 31 face each other (a transferring operation). The toner images formed on four image carriers 40 are sequentially superimposed or layered on the transfer belt 31 to form a composite toner image. Then, the composite toner image is secondarily transferred to the sheet P conveyed from the conveying device 10 at the transfer nip portion R2 where the suspension roller 37 and the secondary transfer roller 33 face each other.

The sheet P to which the composite toner image is secondarily transferred is conveyed to the fixing device 50. Then, the fixing device 50 heats and presses the sheet P between the heating roller 52 and the pressing roller 54 when the sheet P passes through the fixing nip portion. Accordingly, the composite toner image is melted and fixed to the sheet P (a fixing operation). Subsequently, the sheet P is discharged to the outside of the imaging apparatus 1 by the discharging rollers 62 and 64.

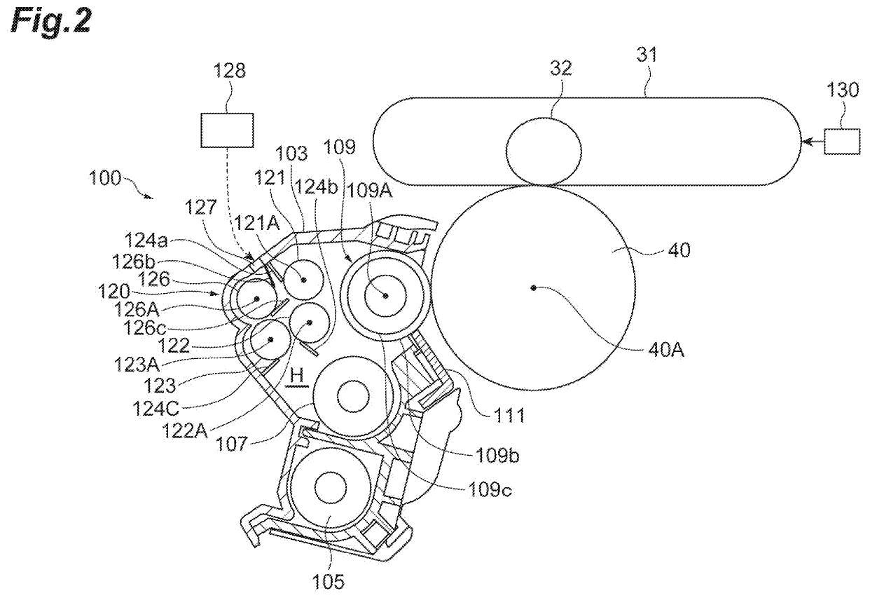

FIG. 2 is a schematic cross-sectional view of the example developing device, for example cut in a vertical direction. FIG. 2 schematically illustrates the example image carrier 40, the example transfer belt 31, the example primary transfer roller 32, and the like along with the example developing device 100. The example developing device 100 illustrated in FIG. 2 includes a storage container 103, a first agitating and conveying member 105, a second agitating and conveying member 107, a rotatable developer carrier 109, a carried amount regulation unit (doctor blade) 111, and an adjustment device 120.

The storage container 103 stores a developer. That is, the storage container 103 forms a developer storage chamber H which stores the developer including the toner, the carrier, and the external additive. The toner may be a colored particle containing a colorant, a release agent, and a binder resin. For example, when toner is produced by the emulsion aggregation method, a polymerizable monomer, a polymerization initiator, an emulsifier (surfactant), and the like are dispersed in water and polymerized to obtain a dispersion liquid containing a particulate binder resin. The obtained dispersion liquid is mixed with a separately prepared dispersion liquid including a colorant, a release agent, a coagulant, and the like. Next, desired mixed colored particles can be produced by coagulating and heat-fusing the obtained mixed dispersion liquid. The average particle diameter of the toner may be about 3 to 10 μm, in some examples. For example, the toner may include particles having an average diameter of about 3 to 10 μm.

The carrier may include a particle as a core material and a resin coat (or resin coating) that coats the surface of the particle. Examples of the particles of the carrier include ferrite, magnetite, iron, and the like. Examples of the resin coating include styrene acrylic resin, acrylic resin, methacrylic resin, and the like. The average particle diameter of the core material is about 10 to 100 μm, in some examples, and the thickness of the resin coating may be about 1 to 2 μm, in some examples.

The external additive may include inorganic fine particles. Examples of the inorganic fine particles include fine particles of silica, alumina, titanium oxide, barium titanate, magnesium titanate, calcium titanate, strontium titanate, zinc oxide, chromium oxide, cerium oxide, antimony trioxide, zirconium oxide, silicon carbide or surface-treated ones thereof, and the like. The average particle diameter of the external additive may be about 1 to 500 nm, in some examples.

The developer may have a state in which the negatively charged toner adheres to the positively charged carrier. Further, the external additive mainly adheres to the surface of the toner to improve fluidity and chargeability of toner. The carrier and the toner have restoring properties. For example, the carrier and the toner have charging performance. The charging performance of the carrier and the toner can be restored by going through a process, even when the performance decreases. Further, even when the charge amount of the carrier and the toner is outside a predetermined range, the charge amount can be restored within a predetermined range by going through a process.

The storage container 103 may house the first agitating and conveying member 105, the second agitating and conveying member 107, the developer carrier 109, the adjustment device 120, and the carried amount regulation unit 111. The storage container 103 may have an opening at a position in which the developer carrier 109 faces the image carrier 40, to supply the toner located inside the developer storage chamber H to the image carrier 40 via the opening. Furthermore, the storage container 103 may be provided with a discharge portion which discharges the old developer from the developer storage chamber H to the outside.

The first agitating and conveying member 105 and the second agitating and conveying member 107 agitate the magnetic carrier and the non-magnetic toner constituting the developer inside the developer storage chamber H and frictionally charge the carrier and the toner. Further, the first agitating and conveying member 105 and the second agitating and conveying member 107 convey the developer while agitating the developer inside the developer storage chamber H. The first agitating and conveying member 105 and the second agitating and conveying member 107 may have a spiral shape. For example, the agitating and conveying member 105 and/or the second agitating and conveying member 107 may include a screw conveyor.

The developer carrier 109 may be disposed while facing the image carrier 40 to form a gap between the image carrier 40 and the developer carrier. For example the developer carrier 109 may be spaced apart from the image carrier 40. The developer carrier 109 has a surface and rotates while carrying the developer stored in the storage container 103 on its surface. The developer carrier 109 may have a columnar or cylindrical shape. The developer carrier 109 may be disposed so that a rotational axis 109A of the developer carrier 109 is parallel to a rotational axis 40A of the image carrier 40 and a gap between the developer carrier 109 and the image carrier 40 becomes constant in the direction of the axis 109A (the direction of the axis 40A). The developer carrier 109 carries the developer agitated by the first agitating and conveying member 105 and the second agitating and conveying member 107 on the surface thereof. The developer carrier 109 develops the electrostatic latent image of the image carrier 40 by conveying the carried developer to the developing region. The developing region is a region in which the developer carrier 109 and the image carrier 40 face each other. The developing region may be a region in which the developer carrier 109 and the image carrier 40 are closest to each other.

The developer carrier 109 may include a developing sleeve 109b which forms a surface layer of the developer carrier 109 and a magnet 109c which is disposed inside the developing sleeve 109b. The developing sleeve 109b is a cylindrical member that is formed of non-magnetic metal. The developing sleeve 109b is rotatable about the axis 109A. The developing sleeve 109b is rotatably supported by, for example, the magnet 109c and is rotated by a driving source (not illustrated) such as a motor. The magnet 109c is fixed to the storage container 103 and includes a plurality of magnetic poles. The developer is carried on the surface of the developing sleeve 109b by the magnetic force of the magnet 109c. The developer carrier 109 conveys the developer in the rotational direction of the developing sleeve 109b by the rotation of the developing sleeve 109b. Accordingly, the toner in the developer carried on the developer carrier 109 moves to the electrostatic latent image formed on the peripheral surface of the image carrier 40 so that the electrostatic latent image is developed. Furthermore, a bias voltage is applied to the developer carrier 109 as an example.

The carried amount regulation unit 111 regulates the carried amount of the developer carried on the developer carrier 109. The carried amount regulation unit 111 is provided on the upstream side of the developing sleeve 109b in the rotational direction with reference to the developing region. The carried amount regulation unit 111 is located below the axis 109A of the developer carrier 109. The carried amount regulation unit 111 forms a predetermined gap between the developing sleeve 109b and the carried amount regulation unit. For this reason, the carried amount regulation unit 111 regulates a layer thickness of the developer carried on the peripheral surface of the developing sleeve 109b by the rotation of the developing sleeve 109b so that the layer thickness becomes uniform. When a gap between the carried amount regulation unit 111 and the developing sleeve 109b is adjusted, the amount of the developer of the developer carrier 109 conveyed to the developing region is adjusted. For example, the carried amount regulation unit 111 may be spaced apart from the developing sleeve 109b by a gap, in order to limit and/or level the thickness of the layer of developer carried on the developing sleeve 109b, according to the gap.

The adjustment device 120 may include a separating device which separates the developer inside the storage container 103 into the carrier and the toner and a restoring device which restores properties of the carrier and the toner generated by the separating device. With reference to FIG. 2, the adjustment device may include three charging rollers 121, 122, and 123 and one external addition roller (additive supply device) 126 in some examples. The charging rollers 121, 122, and 123 have a cylindrical shape and are rotatably provided in the storage container 103. The rotational axes 121A, 122A, and 123A of the charging rollers 121, 122, and 123 are parallel to the axis 109A of the developer carrier 109. The charging rollers 121, 122, and 123 may have a same or similar size and width (or length) as that of the developer carrier 109. With reference to FIG. 2, the charging roller 121 may face the charging roller 122 and the charging roller 122 may face the charging roller 123.

The charging rollers 121, 122, and 123 may be positively or negatively charged to a predetermined charge amount by the control of the control unit of the imaging apparatus 1. Further, the charging rollers 121, 122, and 123 can rotate at a rotation speed in a rotational direction by the control of the control unit of the imaging apparatus 1. In some examples, the charging polarity of the charging roller 121 can be switched between a positive polarity and a negative polarity, the charging polarity of the charging roller 122 may be a negative polarity, and the charging polarity of the charging roller 123 may be a positive polarity. In some examples, the rotation speed of the charging roller 121 and the rotation speed of the charging roller 122 may be controlled to be the same. As an example, the rotation speed of the charging roller 123 can be switched to the same rotation speed as those of the charging rollers 121 and 122 or a rotation speed different from those of the charging rollers 121 and 122. In some examples, with reference to FIG. 2, the charging roller 121 may be controlled to rotate in the clockwise direction, the charging roller 122 may be controlled to rotate in the counterclockwise direction, and the charging roller 123 may be controlled to rotate in the clockwise direction.

The charging roller 121 may be disposed at a highest position among the charging rollers 121, 122, and 123. The rotational axis 121A of the charging roller 121 may be located above the axis 109A of the developer carrier 109.

The charging roller 122 may be disposed below the charging roller 121. The rotational axis 122A of the charging roller 122 may be located below the axis 109A of the developer carrier 109. In some examples, the charging roller 121 and the charging roller 122 are separated from each other at a distance away from the developer passing between the charging roller 121 and the charging roller 122 and an electric field of the charging roller 121 and an electric field of the charging roller 122 can be effectively exhibited at that distance. In some examples, the charging roller 121 and the charging roller 122 are separated from each other by a distance at which the electric field of the charging roller 121 and the electric field of the charging roller 122 operate effectively, in regards to the developer passing between the charging roller 121 and the charging roller 122.

The position of the charging roller 122 and the position of the charging roller 121 may be offset from each other when viewed from the up and down direction. In some examples, the rotational axis 122A of the charging roller 122 is located between the position of the rotational axis 121A of the charging roller 121 and the position of the outer peripheral surface facing the developer carrier 109 in the charging roller 121 when viewed from the up and down direction. For example, the charging roller 122 may be disposed at a position below the charging roller 121 and near the developer carrier 109.

In some examples, the positions of the charging roller 121 and the charging roller 122 may be adjusted so that the developer returned from the developer carrier 109 into the storage container 103 reaches a position of a gap between the charging roller 121 and the charging roller 122.

The charging roller 123 may be located at a lateral side of the charging roller 122. The charging roller 123 may be disposed at a position separated from the developer carrier 109 in relation to the charging roller 122. In some examples, the charging roller 122 is located between the charging roller 123 and the developer carrier 109. The axis 123A of the charging roller 123 may be located below the axis 122A of the charging roller 122. In some examples, the charging roller 122 and the charging roller 123 are separated from each other by a distance substantially equal to the diameter of the carrier.

A scraper 124a may be provided adjacent to the charging roller 121 at a downstream position of the charging roller 121 in the rotational direction in relation to a position in which the charging roller 121 and the charging roller 122 are closest to each other (e.g. the scraper 124a may be provided at a downstream side of a closest position of the charging roller, where the charging roller 121 and the charging roller 122 are closest to each other, relative to the rotational direction of the charging roller 121). A front end of the scraper 124a may contact the outer peripheral surface of the charging roller 121 along the entire region of the width direction (e.g. the scraper 124a may contact the entire length of the charging roller 121).

A scraper 124b may be provided adjacent to the charging roller 122 at a downstream position of the charging roller 122 in the rotational direction in relation to a position in which the charging roller 122 and the charging roller 123 are closest to each other (e.g. the scraper 124b may be provided at a downstream side of a closest position of the charging roller 122, where the charging roller 122 and the charging roller 123 are closest to each other, relative to the rotational direction of the charging roller 122). A front end of the scraper 124b may contact the outer peripheral surface of the charging roller 122 along the entire region of the width direction (e.g. the scraper 124b may contact the entire length of the charging roller 122). Furthermore, the position in which the charging roller 122 and the charging roller 123 are closest to each other may be located downstream of the charging roller 122 in the rotational direction in relation to the position in which the charging roller 121 and the charging roller 122 are closest to each other (e.g. the closest position the charging roller 122 and the charging roller 123 are closest to each other, may be located at a downstream side of the closest position of the charging roller 122 where the charging roller 121 and the charging roller 122 are closest to each other, relative to the rotational direction of the charging roller 123). The scraper 124b may be switched between an electrical ground state and a non-electrical ground state based on the control of the control unit of the imaging apparatus 1. As an example, the scraper 124b may be electrically connected to the ground via a switch that can be switched by the control unit.

A scraper 124c may be provided adjacent to the charging roller 123 at a downstream position of the charging roller 123 in the rotational direction in relation to a position in which the charging roller 122 and the charging roller 123 are closest to each other (e.g. the scraper 124c may be provided at a downstream side of a closest position of the charging roller 123 where the charging roller 122 and the charging roller 123 are closest to each other, relative to the rotational direction of the charging roller 123). A front end of the scraper 124c may contact the outer peripheral surface of the charging roller 123 along the entire region of the width direction (e.g. the scraper 124c may contact the entire length of the charging roller 123). The scraper 124c may be switched between an electrical ground state and a non-electrical ground state based on the control of the control unit of the imaging apparatus 1. As an example, the scraper 124c may be electrically connected to the ground via a switch that can be switched by the control unit.

The external addition roller 126 has a cylindrical shape and is rotatably provided in the storage container 103. A rotational axis 126A of the external addition roller 126 is parallel to the rotational axis 121A of the charging roller 121. That is, as an example, the axis 126A of the external addition roller 126, the axes 121A, 122A, and 123A of the charging rollers 121, 122, and 123, and the axis 109A of the developer carrier 109 are parallel to one another. The external addition roller 126 has the same width (or length) as that of the developer carrier 109. The external addition roller 126 can rotate at a rotation speed in a rotational direction based on the control of the control unit of the imaging apparatus 1. As an example, the external addition roller 126 is controlled to rotate in the clockwise direction.

The external addition roller 126 is located at a position below (e.g. a position lower than) the charging roller 121 and above (e.g. a position higher than) the charging roller 123. In the example illustrated in the drawings, the charging roller 121 and the charging roller 122 are located between the external addition roller 126 and the developer carrier 109.

Further, in some examples, with reference to FIG. 2, an external additive supply port 127 may be formed in the storage container 103. An external additive supply container 128 storing the external additive is connected to the supply port 127. The external additive stored in the external additive supply container 128 is input to the supply port 127 based on a control from the control unit of the imaging apparatus 1. As an example, the external additive supply container 128 may be provided with a conveying mechanism that conveys the external additive to the supply port 127 based on the control of the control unit.

In FIG. 2, the supply port 127 is located above the external addition roller 126. In the external addition roller 126, an external additive regulation blade 126b is provided adjacent to the external addition roller 126 at a downstream position in the rotational direction in relation to a position facing the supply port 127 (e.g. the regulation blade 126b may be located adjacent to the external addition roller 126 at a downstream side of a position on the external addition roller 126 where the external addition roller 126 faces the supply port 127). A front end of the external additive regulation blade 126b contacts the outer peripheral surface of the external addition roller 126. In some examples, the external additive regulation blade 126b is formed in a plate shape having the same width (or length) as that of the external addition roller 126 and contacts the external addition roller 126 along the entire region of the width direction (e.g. the external addition blade 126c contacts the entire length of the external addition roller 126).

In FIG. 2, an external addition blade (additive supply device) 126c is provided adjacent to the external addition roller 126 at a downstream position of the rotational direction in relation to the contact position of the external additive regulation blade 126b. A front end of the external addition blade 126c contacts the outer peripheral surface of the external addition roller 126. The external addition blade 126c is disposed below the scraper 124a contacting the charging roller 121. In some examples, the external addition blade 126c has a plate shape having the same width (or length) as that of the external addition roller 126 and contacts the external addition roller 126 along the entire region of the width direction (e.g. the external addition blade 126c contacts the entire length of the external addition roller 126).

In some examples, a sensor (measurement device) 130 which measures the amount of the toner transferred to the transfer belt 31 is provided. The sensor 130 may include a light emitting element and a light receiving element and may detect the amount of the toner adhering to the transfer belt 31 in such a manner that the reflected light of the light irradiated from the light emitting element to the transfer belt 31 is received by the light receiving element. The sensor 130 may measure (estimates) the current charge amount of the developer based on the voltage applied to the developer carrier 109, the voltage applied to the image carrier 40, and the toner adhering amount.

In the example developing device 100, the adjustment device 120 can restore the properties of the developer inside the storage container 103 in response to the charge amount of the developer measured by the sensor 130. The adjustment device 120 is operated when the charge amount of the developer measured by the sensor 130 is outside a predetermined range and is stopped when the charge amount of the developer measured by the sensor 130 is within the predetermined range. Furthermore, the predetermined range is defined by an upper threshold value and a lower threshold value less than the upper threshold value. By way of example, the adjustment device 120 may decrease the charge amount of the toner and the charge amount of the carrier when the charge amount of the developer measured by the sensor 130 is greater than the upper threshold value. By way of further example, the adjustment device 120 may supply the external additive to the toner and strips off the surfaces of the particles of the carrier when the charge amount of the developer measured by the sensor 130 is less than the lower threshold value.

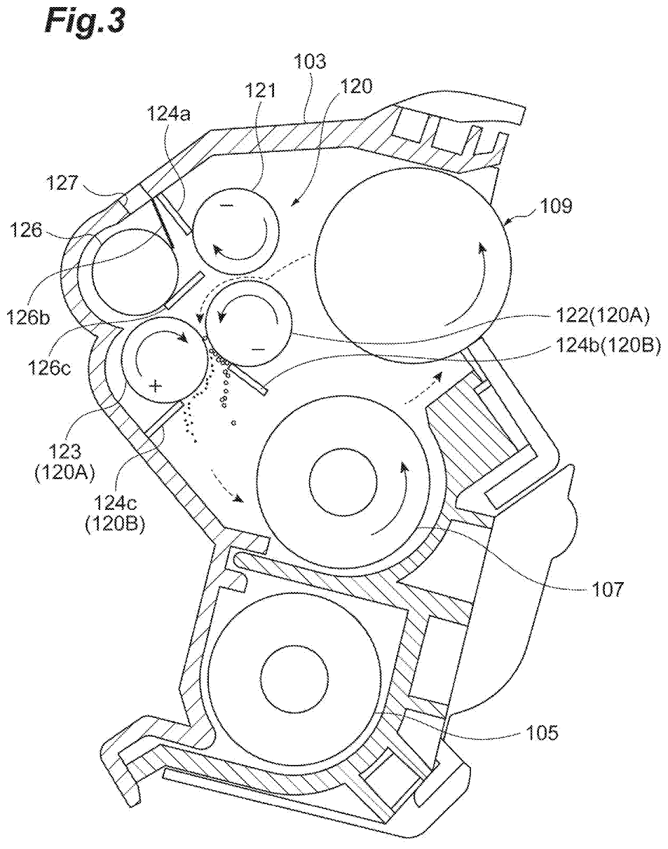

An example operation of the adjustment device 120 will be described, with reference to FIG. 3. An operation for a case in which the charge amount of the developer is substantially large will be described. For example, in such a case, the charge amount measured by the sensor 130 may be greater than the upper threshold value. FIG. 3 is a cross-sectional view of the adjustment device 120, schematically illustrating an operation of the adjustment device 120 in a case in which the charge amount of the developer is greater than the upper threshold value.

With reference to FIG. 3, when the charge amount of the developer is greater than the upper threshold value, the charging roller 121 rotates in the clockwise direction while being negatively charged. The charging roller 122 rotates in the counterclockwise direction of the drawing while being negatively charged. The charging roller 123 rotates in the clockwise direction of the drawing while being positively charged. The absolute charge amount values of the charging rollers 121, 122, and 123 may be the same. The charging rollers 121, 122, and 123 are controlled at the same rotation speed. The scrapers 124b and 124c are respectively electrically connected to the ground. The operation of the external addition roller 126 is stopped. In the example illustrated in FIG. 3, the charging roller (the second roller) 122 and the charging roller (the first roller) 123 constitute a separating device 120A and the scraper (the second grounding member) 124b and the scraper (the first grounding member) 124c constitute a restoring device 120B.

The developer conveyed to the developing region of the developer carrier 109 by the operations of the first agitating and conveying member 105, the second agitating and conveying member 107, and the developer carrier 109 returns into the storage container 103 again and is separated from the developer carrier 109. Furthermore, a flow of the developer in FIG. 3 is indicated by a dashed arrow. For better ease of understanding, the carrier is schematically represented by white circles and the toner is schematically represented by black dots. The developer separated from the developer carrier 109 passes through a gap between the charging roller 121 and the charging roller 122. Then, the developer is conveyed to a gap between the charging roller 122 and the charging roller 123 in accordance with the rotation of the rotating charging roller 122 due to the influence of gravity. In the gap, the positively charged carrier in the developer is attracted to the negatively charged charging roller 122 and the negatively charged toner (or the toner group mainly including the toner) in the developer is attracted to the positively charged charging roller 123. That is, the developer is separated into the carrier and the toner by the separating device 120A (the charging rollers 122 and 123). The carrier separated from the developer by the charging roller 122 may be a carrier group mainly including the carrier. Further, the toner separated from the developer by the charging roller 123 may be a toner group mainly including the toner.

The carrier attracted to the charging roller 122 is conveyed downstream in the rotational direction in accordance with the rotation of the charging roller 122 and contacts the scraper 124b. The carrier contacting the scraper 124b is decreased in charge amount and stripped off from the charging roller 122 by the scraper 124b electrically connected to the ground. The toner attracted to the charging roller 123 is conveyed downstream in the rotational direction in accordance with the rotation of the charging roller 123 and contacts the scraper 124c. The toner contacting the scraper 124c is decreased in charge amount and stripped off from the charging roller 123 by the scraper 124c electrically connected to the ground. For example, the charge amount which is an example of the properties of the carrier and the toner may be restored from an excessively high state by the restoring device 120B. The carrier and the toner of which the charge amount decreases are agitated again by the second agitating and conveying member 107 and the like.

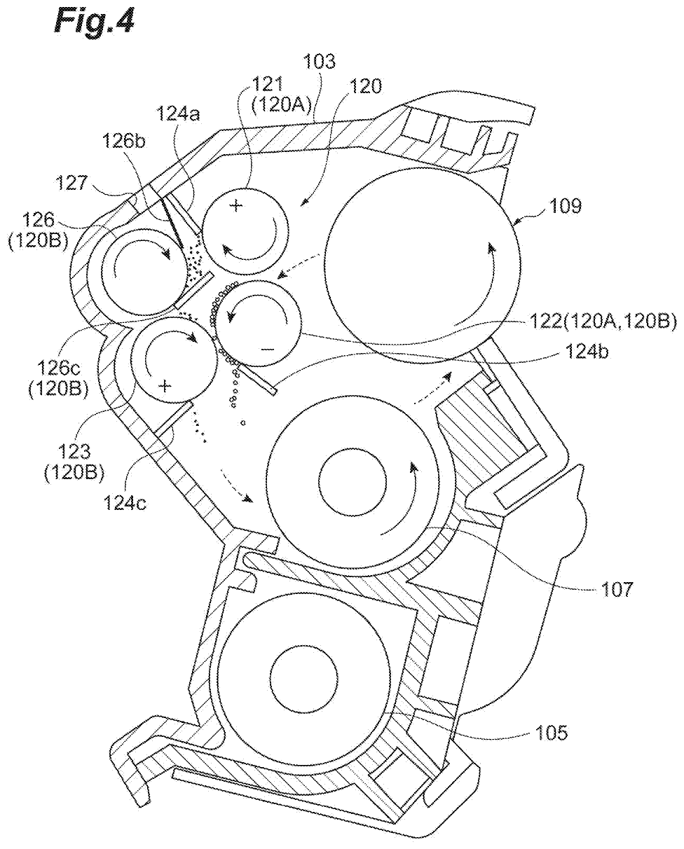

An example operation of the example adjustment device 120 for a case in which the charge amount of the developer is substantially small will be described with reference to FIG. 4. For example, in such a case, the charge amount measured by the sensor 130 may be less than the lower threshold value. FIG. 4 is a cross-sectional view of the adjustment device 120, schematically illustrating an example operation of the adjustment device for a case in which the charge amount of the developer is less than the lower threshold value.

With reference to FIG. 4, when the charge amount of the developer is less than the lower threshold value, the charging roller 121 rotates in the clockwise direction while being positively charged. The charging roller 122 rotates in the counterclockwise direction while being negatively charged. The charging roller 123 rotates in the clockwise direction while being positively charged. The absolute charge amount values of the charging rollers 121, 122, and 123 may be substantially the same. The charging rollers 121 and 122 are adjusted to the same rotation speed and the rotation speed of the charging roller 123 is adjusted to be different from those of the charging rollers 121 and 122. By way of example, the rotation speed of the charging roller 123 is adjusted to be faster than those of the charging rollers 121 and 122. The scrapers 124b and 124c may not be electrically connected to the ground. The external addition roller 126 rotates in the clockwise direction of the drawing. The external additive supplied from the supply port 127 is pressed against the outer peripheral surface of the external addition roller 126 by the external additive regulation blade 126b, so that the external additive adheres to the outer peripheral surface of the external addition roller 126. The external additive can be supplied from the external additive supply container 128 through the supply port 127 when the operation time of the external addition roller 126 elapses by a predetermined time (e.g. when the operation time of the additive supply device reaches a threshold time).

In the example illustrated in FIG. 4, the charging roller (the first roller) 121 and the charging roller (the second roller) 122 constitute the separating device 120A and the external addition roller 126, the external addition blade 126c, the charging roller (the stripping device, the second roller) 122, and the charging roller (the stripping device, the third roller) 123 constitute the restoring device 120B.

By the operations of the first agitating and conveying member 105, the second agitating and conveying member 107, and the developer carrier 109, the developer conveyed to the developing region of the developer carrier 109 returns into the storage container 103 again and is separated from the developer carrier 109. A flow of the developer in FIG. 4 is indicated by a dashed arrow. For better ease of understanding, the carrier is schematically represented by white circles and the toner is represented by black dots. The developer separated from the developer carrier 109 passes through a gap between the charging roller 121 and the charging roller 122. In the gap, the positively charged carrier in the developer is attracted to the negatively charged charging roller 122 and the negatively charged toner in the developer is attracted to the positively charged charging roller 121. The carrier attracted to the charging roller 122 may be the carrier group mainly including the carrier. Further, the toner attracted to the charging roller 123 may be the toner group mainly including the toner.

The carrier attracted to the charging roller 122 is conveyed downstream in the rotational direction in accordance with the rotation of the charging roller 122 and passes through a gap between the charging roller 122 and the charging roller 123. The surfaces of the particles of the carrier are stripped off when the carrier passes through a gap between the charging roller 122 and the charging roller 123. For example, the carrier may receive a mechanical stress in the gap. The mechanical stress may be caused by a difference between the rotation speed of the charging roller 122 and the rotation speed of the charging roller 123. The carrier which moves at the rotation speed of the charging roller 122 may contact the charging roller 123 rotating at a speed faster than the rotation speed of the charging roller 122. Accordingly, the surface layer of the coating of the carrier is stripped off by the charging roller 123. The carrier of which the surface layer of the coating is stripped off, is stripped off from the charging roller 122 by the scraper 124b.

The toner attracted to the charging roller 121 is conveyed downstream in the rotational direction in accordance with the rotation of the charging roller 121 and is stripped off from the charging roller 121 by the scraper 124a. The stripped toner falls onto the external addition blade 126c. The falling toner is pressed against the outer peripheral surface of the external addition roller 126 by the external addition blade 126c. Since the external additive adheres to the outer peripheral surface of the external addition roller, the external additive is supplied to the toner. The toner to which the external additive is supplied is absorbed to the positively charged charging roller 123. The toner is stripped off from the charging roller 123 by the scraper 124c. The carrier from which the surface layer of the coating is stripped off and the toner to which the external additive is added again are agitated again by the second agitating and conveying member 107 and the like.

In a two-component developing system including the carrier, the toner, and the external additive, the external additive may become buried into the surface of the toner when a printing process is performed at a low printing rate for a long time in a high temperature environment. When the external additive is buried in the surface of the toner, the spacer effect provided by the external additive is reduced and the fluidity of the toner is lowered. As the fluidity of the toner decreases, the number of contacts between the toner and the carrier decreases and the charging performance decreases. Further, when the external additive is buried in the surface of the toner, the surface of the toner is covered with resin forming the toner. Accordingly, the work function difference between the toner and the carrier is reduced and the charging performance is deteriorated. In this case, the density of the image to be formed increases and toner adhesion on the image background may occur unnecessarily.

Further, when a printing process is performed at a low printing rate for a long time in a low temperature environment, the toner that is not used repeats contact and separation with carrier and hence the charge amount of the developer increases. In this case, the density of the image to be formed decreases.

Further, when a printing process is performed at a low printing rate for a long time regardless of the temperature environment, the toner may become buried into the surface layer of the coating of the carrier. When the external additive is buried in the coating of the carrier, the contact between the external additive adhering to the toner and the coating of the carrier is lessened, and hence the charging performance is deteriorated.

In the example imaging system, since the developer inside the storage container 103 is separated into the carrier and the toner by the separating device 120A, the property of the carrier and the property of the toner can be separately restored by the restoring device 120B.

When the separating device 120A includes the charging roller 121 and the charging roller 122 which face each other, the toner is separated from the developer by the positively charged charging roller 121 and the carrier is separated from the developer by the negatively charged charging roller 122. Further, when the separating device 120A includes the charging roller 123 and the charging roller 122 which face each other, the toner is separated from the developer by the positively charged charging roller 123 and the carrier is separated from the developer by the negatively charged charging roller 122. In this configuration, after the developer is separated into the carrier and the toner, the carrier and the toner are promptly conveyed to the restoring device 120B, separately. Accordingly, the properties of the carrier and the toner are efficiently restored.

In some examples, with reference to FIG. 3, the charging roller 123 and the charging roller 122 constituting the separating device 120A rotate at the same speed. In some examples, with reference to FIG. 4, the charging roller 121 and the charging roller 122 constituting the separating device 120A rotate at the same speed. In such examples, since the rollers of the separating device 120A rotate at the same speed, damage added from the roller to the developer when passing between the rollers is suppressed. For example, the rollers rotating at the same speed may inhibit the roller from damaging the developer when the developer passes between the rollers.

In some examples, with reference to FIG. 3, the scraper 124c electrically connected to the ground is adjacent to the charging roller 123 and the scraper 124b electrically connected to the ground is adjacent to the charging roller 122. In such examples, the charge amount of the carrier and the toner separated by the charging roller 123 and the charging roller 122 may be promptly lessened by the scrapers 124c and 124b.

The restoring device 120B includes the additive supply device to which the toner separated by the separating device 120A is supplied. The additive supply device includes the external addition roller 126 and the external addition blade 126c. The external additive is supplied to the toner supplied to the additive supply device. As described above, when the charge amount of the developer is low, there may be a case in which the surface of the toner is covered with resin. Since the restoring device 120B supplies the external additive to the toner, the external additive adheres to the surface of the toner. Accordingly, the charging performance of the toner is restored.

The example additive supply device supplies the external additive to the toner by pressing the toner with the external addition blade 126c, against the external addition roller 126. In the example additive supply device, the external additive can be supplied to the toner with a simple configuration.

The storage container 103 is provided with the supply port 127 which supplies the external additive to the additive supply device. Since the external additive is supplied from the supply port 127, the supply of the external additive with respect to the toner can be carried out for a long time.

The external additive is supplied from the supply port when the operation time of the external addition roller 126 elapses by a predetermined time (e.g. when the operation time of the additive supply device reaches a threshold time). Since the external additive supply timing is determined based on the operation time of the external addition roller 126, the unnecessary supply of external additive is suppressed.

The restoring device 120B may include the stripping device (the charging roller 123) to which the carrier separated by the separating device 120A is supplied. The charging roller 123 strips off the surfaces of the particles of the supplied carrier. As described above, when the charge amount of the developer is low, there is a case in which the surface of the carrier is covered with the buried external additive. As an example, since the surfaces of the particles of the carrier are stripped off, the external additive is removed from the coating of the carrier. Accordingly, the charging performance of the carrier is restored.

The surfaces of the particles of the carrier separated from the developer by the charging roller 122 are stripped off when the carrier passes through a gap between the charging roller 122 and the charging roller 123. In this case, the charging roller 122 and the charging roller 123 may rotate at different speeds. Due to a difference in rotation speed between the charging roller 122 and the charging roller 123, the surface of the carrier can be efficiently stripped off.

Since the example imaging apparatus 1 includes the sensor 130 which measures the charge amount of the developer, it is possible to accurately restore the states of the carrier and the toner in response to the degree of the charge amount of the developer. For example, the restoring device 120B may decrease the charge amount of the toner and the charge amount of the carrier when the charge amount of the developer is large and supplies the external additive to the toner and strips off the surfaces of the particles of the carrier when the charge amount of the developer is small.

The adjustment device 120 is operated when the charge amount of the developer measured by the sensor 130 is outside a range defined by the upper threshold value and the lower threshold value and is stopped when the charge amount of the developer measured by the sensor is inside the range. In this way, since an unnecessary operation is not performed, the adjustment device 120 can be efficiently operated.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

1. An imaging system comprising:
a storage container to store a developer including carrier and toner having restoring properties;
a separating device to separate the developer in the storage container into the carrier and the toner; and
a restoring device to restore properties of the carrier and the toner generated by the separating device.

2. The imaging system according to claim 1,
wherein the separating device includes a first roller and a second roller which face each other,
wherein the first roller is positively charged to separate the toner from the developer, and
wherein the second roller is negatively charged to separate the carrier from the developer.

3. The imaging system according to claim 2,
the first roller and the second roller to rotate at a same speed.

4. The imaging system according to claim 2,
wherein a first grounding member is adjacent to the first roller and a second grounding member is adjacent to the second roller.

5. The imaging system according to claim 1,
wherein the restoring device includes an additive supply device to which the toner separated by the separating device is supplied, and
the additive supply device to add external additive to the supplied toner.

6. The imaging system according to claim 5,
wherein the additive supply device includes an external addition roller having a peripheral surface to receive the external additive and a blade adjacent to the external addition roller, and
the additive supply device to supply the external additive to the toner by pressing the toner against the external addition roller by the blade.

7. The imaging system according to claim 5,
wherein the storage container includes a supply port to supply the external additive to the additive supply device.

8. The imaging system according to claim 7,
the supply port to supply the external additive when an operation time of the additive supply device reaches a threshold time.

9. The imaging system according to claim 1,
wherein the restoring device includes a stripping device to receive the carrier separated by the separating device, and
the stripping device to strip off surfaces of particles of the carrier received.

10. The imaging system according to claim 9,
wherein the separating device includes a first roller and a second roller which faces the first roller,
wherein the first roller is positively charged to separate the toner from the developer,
wherein the second roller is negatively charged to separate the carrier from the developer,
wherein the stripping device includes a third roller which faces the second roller to strip off the surfaces of the particles of the carrier separated by the second roller when the carrier passes between the second roller and the third roller.

11. The imaging system according to claim 10,
the third roller and the second roller to rotate at different speeds.

12. The imaging system according to claim 1, comprising:
a measurement device to measure a charge amount of the developer.

13. The imaging system according to claim 12,
the restoring device to operate when the charge amount of the developer measured by the measurement device is outside a range, wherein the range is defined by an upper threshold value and by a lower threshold value that is less than the upper threshold value, and
the restoring device to stop operating when the charge amount of the developer measured by the measurement device is within the range.

14. The imaging system according to claim 13,
the restoring device to decrease a charge amount of the toner and a charge amount of the carrier when the charge amount of the developer measured by the measurement device is greater than the upper threshold value, and the restoring device to supply external additive to the toner and to strip off surfaces of particles of the carrier when the charge amount of the developer measured by the measurement device is less than the lower threshold value.

15. An imaging system comprising:
a storage container to store a developer including carrier, toner, and external additive, wherein the carrier and the toner have restoring properties;
a separating device located inside the storage container, the separating device to separate the developer into a carrier group including mainly the carrier and a toner group including mainly the toner, wherein the separating device includes a first roller having a positive charge to attract a negative charge of the toner and to generate the toner group, and wherein the separating device includes a second roller to attract a positive charge of the carrier and to generate the carrier group; and
a restoring device to restore properties of the carrier of the carrier group and the toner of the toner group, wherein the restoring device includes a first grounding member adjacent to the first roller, a second grounding member adjacent to the second roller, an additive supply device, and a stripping device,
wherein when a charge amount of the developer is greater than an upper threshold value, the first grounding member to decrease a charge amount of the toner group and the second grounding member to decrease a charge amount of the carrier group, and
wherein when the charge amount of the developer is less than a lower threshold value, the additive supply device to supply the external additive to the toner included in the toner group and the stripping device to strip off surfaces of particles of the carrier included in the carrier group.
